(19) United States
(12) Patent Application Publication
(10) Pub. No.: US 2016/0080472 A1
(43) Pub. Date: Mar. 17, 2016

(54) Measuring Sharing Behavior and Audience Coverage in Online Communities

(71) Applicants: David Andrew Huffaker, Palo Alto, CA (US); Makoto Uchida, Tokyo (JP); Gueorgi Kossinets, San Francisco, CA (US); Jonathan Terleski, Mountain View, CA (US)

(72) Inventors: David Andrew Huffaker, Palo Alto, CA (US); Makoto Uchida, Tokyo (JP); Gueorgi Kossinets, San Francisco, CA (US); Jonathan Terleski, Mountain View, CA (US)

(73) Assignee: Google Inc., Mountain View, CA (US)

(21) Appl. No.: 13/291,471

(22) Filed: Nov. 8, 2011

(51) Int. Cl. H04L 29/08; G06T 11/20

(52) U.S. Cl. CPC H04L 67/10; G06T 11/206

(57) ABSTRACT

Configurations for measuring sharing behavior and audience coverage for one or more users are provided. Some configurations can include the following components: an input processor (IP), a data processor (DP) and a visualization processor (VP). The IP extracts data from user logs or processes existing raw data, and prepares the data for the data processor. In one example, the IP transforms each user record into a structured file including time-ordered data corresponding to instances of information sharing activity, target users, and associated date-time(s) for the sharing activity. The DP takes the time-ordered data from the IP and performs statistical evaluations to classify and determine the audience coverage and sharing behavior. The VP receives processed data from the DP and generates different graphical visualizations (e.g., one or more graphs) based on the statistical analysis provided by the DP.

### BACKGROUND

Activity can occur between a user and one or more recipients for sharing different types of content.

### SUMMARY

The subject technology provides for measuring sharing behavior and audience coverage for one or more users. The subject technology receives data aggregating one or more instances of information sharing by the one or more users over a predetermined period of time. Each instance of information sharing includes shared content from a user of the one or more users. The subject technology then identifies one or more audience types corresponding to recipients of the shared contents. Next, the subject technology determines a proportion of information sharing to each of the one or more audience types for the one or more users over the predetermined period of time. The determined proportion of information sharing to each of the one or more audience types helps define, in part, a pattern of audience diversity for information sharing over time.

The subject technology further provides a system for measuring sharing behavior and audience coverage for one or more users. The system includes memory, one or more processors, and one or more modules stored in memory and configured for execution by the one or more processors. The system includes an input processor module configured to extract sharing data from one or more sources of sharing data and generate time-ordered sharing data based on the extracted sharing data. The system further includes a data processor module configured to process the time-ordered sharing data from the input processor and perform one or more statistical evaluations to classify audience coverage and sharing behavior based on the time-ordered data. Additionally, the system includes a visualization processor module configured to provide for display one or more graphical representations of the one or more statistical evaluations from the data processor module.

Yet another aspect of the subject technology provides for receiving data aggregating one or more instances of information sharing by the one or more users over a predetermined period of time in which each instance of information sharing includes shared content from a user. The subject technology identifies one or more audience types corresponding to recipients of the shared contents. The subject technology then determines a proportion of information sharing to each of the one or more audience types for the one or more users over the predetermined period of time. The determined proportion of information sharing to each of the one or more audience types helps define, in part, a pattern of audience diversity for information sharing over time. Further, the subject technology determines a proportion of all of the instances of information sharing during the predetermined period of time over all of the audience types.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the following figures.

FIG. 1 conceptually illustrates an example process for measuring sharing behavior and audience coverage for one or more users.

FIG. 2 conceptually illustrates an example process for generating graphical representations of statistical evaluations of sharing activity.

FIG. 3 conceptually illustrates an example visualization for sharing options and audience diversity over time for one or more users.

FIG. 4 conceptually illustrates an example visualization for a distribution of audience diversity value using a Gini coefficient.

FIG. 5 conceptually illustrates an example computing environment.

FIG. 6 conceptually illustrates an example application programming interface (API) architecture.

FIG. 7 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In a given social networking service, millions of users on a daily basis are sharing different content (e.g., text data, pictures, video, audio, links, location data, etc.) with other users in their social graphs. For instance, a user can share content with one or more recipients (an “audience” which can include different users within or outside of the social networking service). As sharing activity occurs throughout a period of time (e.g., a day, a week, etc.), each instance of information sharing can include different audience coverage in which content is shared to a different subset of users or recipients (e.g., a group of users, an individual user, etc.). As used herein, “information sharing” refers to one-to-one or one-to-many exchanges of data (e.g., one or more types of content) between a sender and one or more recipients. Instances of information sharing can be implemented utilizing any open or proprietary protocols, message and file formats. The subject technology provides a tool to determine sharing activity for one or more users over a specified period of time. In particular, configurations for a system and method for identifying and visualizing the sharing behavior and audience coverage of users are described. In some configurations, each user can opt-out of having their sharing activity processed by the subject technology.

To provide the aforementioned features, some configurations can include the following components: an input processor (IP), a data processor (DP) and a visualization processor (VP). The IP extracts data from user logs or processes existing raw data, and prepares the data for the data processor. In one example, the IP transforms each user record into a structured file including time-ordered data corresponding to instances of information sharing activity, target users, and associated date-time(s) for the sharing activity. The DP takes the time-ordered data from the IP and performs statistical evaluations to classify and determine the audience coverage and sharing behavior.

One statistical technique involves determining the proportion of sharing to a particular audience over time. For instance, when a user shares several items to a potential audience, the user may share 20% of the user's total activity to one group, and 80% to another group. By tracing the ratio over time, an overall pattern of audience diversity and how the pattern changes over time can be determined. Another statistical technique involves the Gini coefficient which is a measure of the inequality of a distribution (e.g., a value of 0 expressing total equality and a value of 1 maximum inequality). By way of example, some configurations determine the Gini coefficient by determining all sharing activities in a time period X and calculating the proportion of that sharing over all audience options or types (e.g., predefined groups, custom groups, individuals, public, shared, etc.). The VP receives processed data from the DP and generates different graphical visualizations (e.g., one or more graphs) based on the statistical analysis provided by the DP.

In some configurations, an administrator can then segment users based on the visualization(s) of the sharing behavior and audience coverage to enhance the user experience. For instance, within a social networking service, a user can be targeted for a particular feature (or advertisement) based on the audience coverage and sharing behavior associated with the user. Additionally, as mentioned above, each user may opt-out of having their sharing behavior tracked by the subject technology.

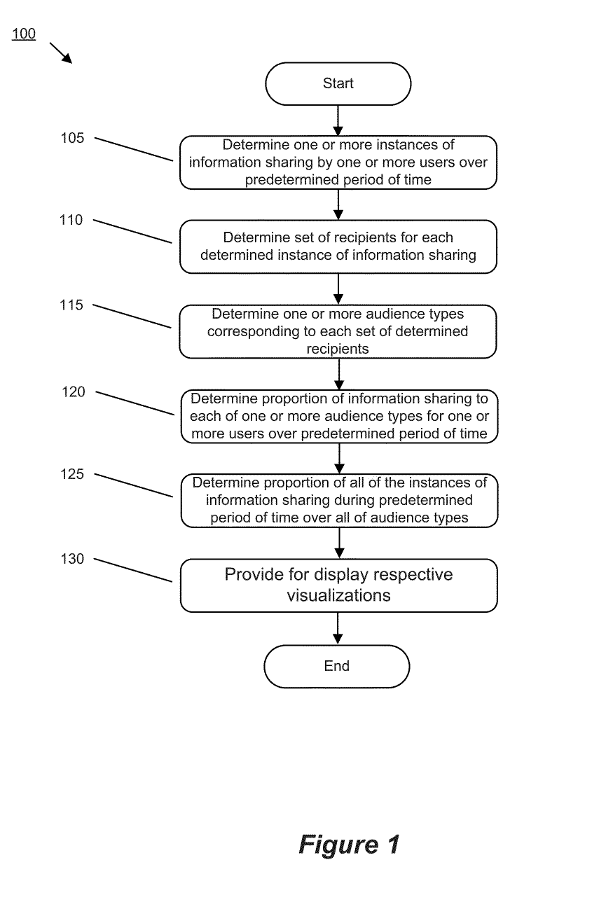

FIG. 1 conceptually illustrates an example process 100 performed on one or more computing devices or systems for measuring sharing behavior and audience coverage for one or more users. The process 100 can be implemented in a system that accesses a source of sharing data (e.g., shared media in a social networking service, any e-mail from a list of contacts, or any other form of information linked between at least two users).

The process 100 starts at 105 by receiving data aggregating one or more instances of information sharing by the one or more users over a predetermined period of time. The predetermined period of time can include time periods such as a day, a week, several weeks, a month, several months, a year, and several years, any combination of the aforementioned time periods, etc. Each instance of information sharing includes shared content from a user to at least one recipient. As mentioned before, “information sharing” refers to one-to-one or one-to-many exchanges of data (e.g., one or more types of content) between a sender and one or more recipients. The shared content from the user includes at least one of text, picture, video, audio, link, and location data. Other types of content can be shared by the user and still be within the scope of the subject technology.

The process 100 at 110 identifies one or more audience types corresponding to recipients of the shared contents. The phrase “audience type” as used herein includes its plain and ordinary meaning, including, but not limited to, one or more different recipients in one or more different categories (e.g., according to a type of relationship and/or based one or more different criteria, etc.). For instance, the recipients can include one or more contacts (e.g., via one or more services such as e-mail, social networking, chat, etc.) of a user. In this regard, the one or more audience types includes a set of recipients including a predetermined group of recipients, a user-defined group of recipients, an individual recipient, and/or one or more different social circles. The one or more audience types further includes different levels of access for the shared contents including public access or limited access. In one example, the recipients can include social circles as an audience for shared content. As used herein, social circles are categories to which a user can assign their social networking contacts and better control the distribution and visibility of social networking messages.

For instance, a social circle can be provided as a data set defining a collection of contacts that are associated with one another. A social circle can be described from the perspective of an individual that is the center of a particular collection of socially interconnected people, or from the aggregate perspective of a collection of socially interconnected people. For example, a user of an electronic device may have different groups of friends, coworkers, and family, and there may be some overlap among those groups (e.g., a coworker who is also considered to be a friend, a family member who is also a coworker). Through the creation and use of social circles, the user can organize and categorize social networking contacts into various different groupings.

The process 100 at 115 determines a proportion of information sharing to each of the one or more audience types for the one or more users over the predetermined period of time. As used herein, the expression “proportion of information sharing” includes its plain and ordinary meaning, including, but not limited to, a ratio (e.g., a percentage, fraction, etc.) of information sharing to each of the one or more audience types. The determined proportion of information sharing to each of the one or more audience types helps define, in part, a pattern of audience diversity for information sharing over time. In one example, the subject technology can utilize the pattern of audience diversity in order to track the sharing activity of one or more users in a service such as a social networking service. The pattern of audience diversity can be mapped or visualized in a graphical form over the predetermined period of time so that trends can be determined. For instance, a user's sharing activity can indicate that the user may be a more active sharer of content if the proportion of information sharing to each audience type is at a certain percentage. By way of example, the user may share 45% of content to a first audience type, 35% to a second audience type and 20% to a third audience type. Thus, during the predetermined period of time, the proportion of all of the instances of information sharing over all of the audience types varies based on a number of audience types.

The process 100 then continues to 120 in order to determine, during the predetermined period of time, a proportion of all of the instances of information sharing over all of the audience types. The proportion of all of the instances of information sharing (during the predetermined period of time) over all of the audience types is a Gini coefficient in one example.

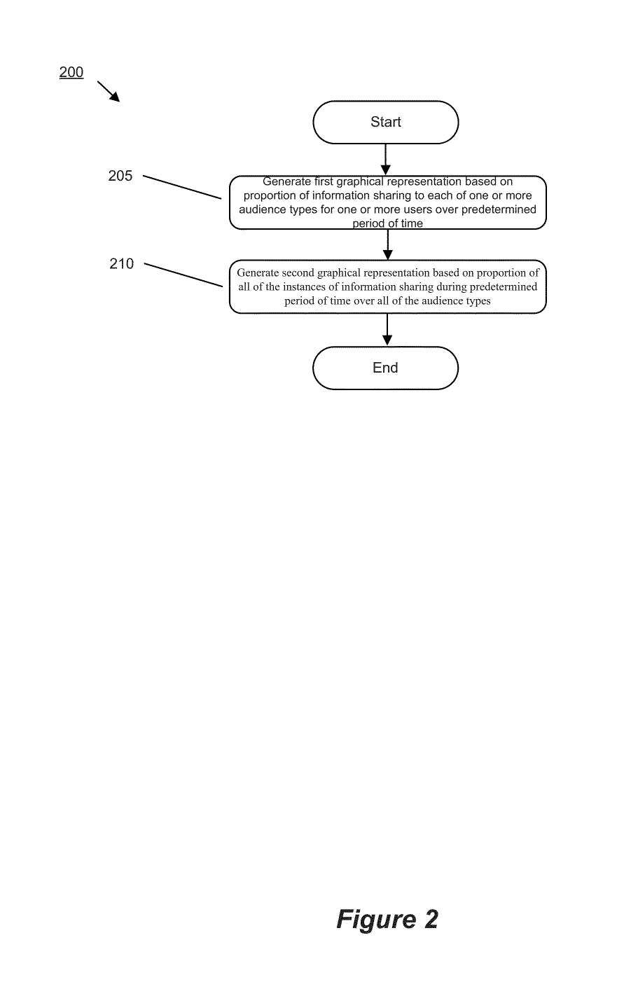

Next, the process 100 at 125 provides for display respective visualizations of the determined proportion of information sharing to each of the one or more audience types and the determined proportion of all of the instances of information sharing. The discussion of visualizations will be described in further detail in FIGS. 2-4 described below. The process 100 then ends.

FIG. 2 conceptually illustrates an example process 200 performed on one or more computing devices or systems for generating graphical representations of statistical evaluations of sharing activity. More specifically, the process 200 generates respective graphical representations for a proportion of information sharing to each of one or more audience types and/or a proportion of all instances of information sharing over all audience types determined from the operations in FIG. 1 described above. In one example, the operations of the process 200 can be performed conjunctively with the process 100 illustrated in FIG. 1. For instance, one or more operations of the process 200 can be performed at 125 in FIG. 1.

The process 200 starts at 205 by generating a first graphical representation based on a proportion of information sharing to each of one or more audience types for one or more users over a predetermined period of time. Referring to FIG. 1, the process 100 can determine the proportion of information sharing to each of the one or more audience types for one or more users at 115. The process 200 therefore can utilize the determined proportion of information sharing from the process 100 in order to generate the first graphical representation.

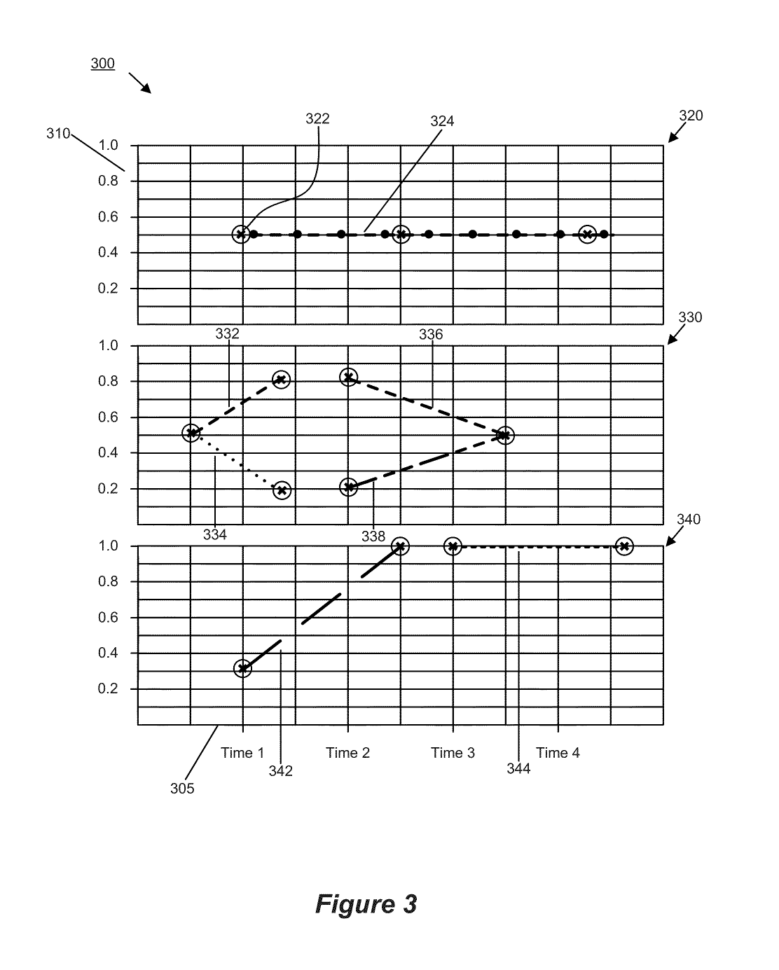

The first graphical representation indicates a pattern of audience diversity over the predetermined period of time. The first graphical representation can be a graph with an X-axis representing a first parameter and a Y-axis representing a second parameter. In one example, the first parameter represents time and the second parameter represents a proportion of audience coverage to one or more different audience types. An example of the aforementioned graph is illustrated in more detail in FIG. 3.

The process 200 then continues to 210 to generate a second graphical representation based on a proportion of all instances of information sharing during a predetermined period of time over all audience types. Referring to FIG. 1, the process 100 can determine the proportion of all instances of information sharing during the predetermined period of time over all audience types at 120. The process 200 therefore can utilize the determined proportion of all instances of information sharing from the process 100 in order to generate the second graphical representation.

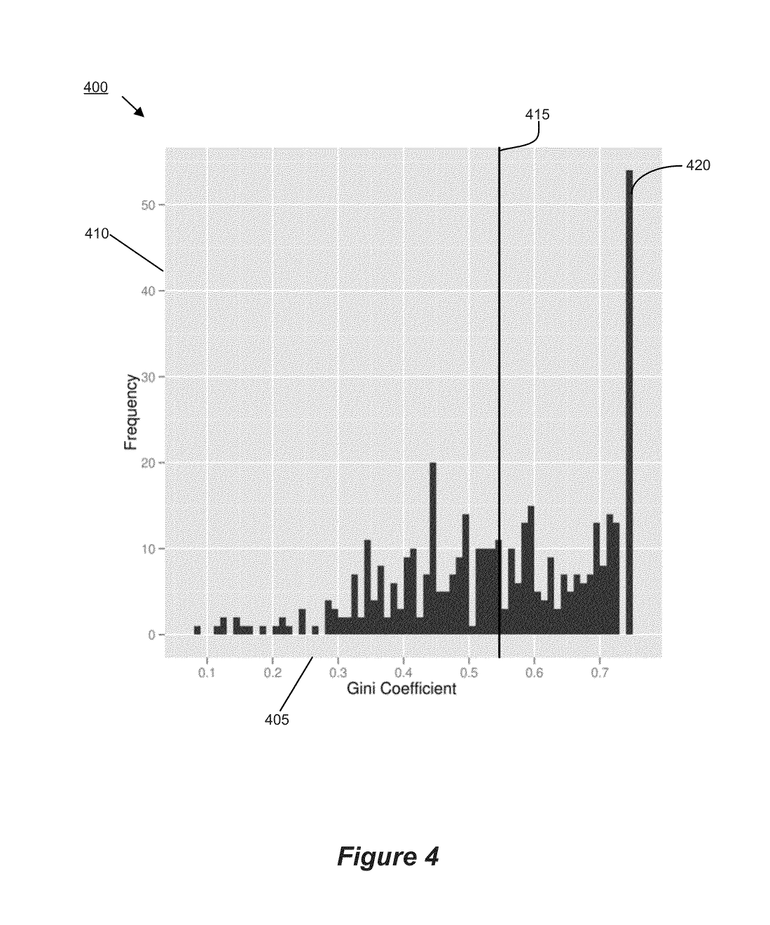

The second representation can be a graph with an X-axis representing a first parameter and a Y-axis representing a second parameter. In one example, the first parameter represents a Gini coefficient value and the second parameter represents a frequency value. An example of the aforementioned graph is illustrated in more detail in FIG. 4. The process 200 then ends.

FIG. 3 conceptually illustrates an example visualization 300 for sharing options and audience diversity over time for one or more users. In one example, the visualization 300 can be provided for displayed in conjunction with the operations performs in the processes 100 and 200 respectively in FIGS. 1 and 2. The examples shown in FIG. 3 illustrate the dynamics of sharing activity for one or more users over a predetermined period of time.

As illustrated, the visualization 300 can be a one or more discrete graphs 320, 330 and 340 respectively corresponding to sharing activity for a particular user. Each of the graphs 320, 330 and 340 includes an X-axis (e.g., X-axis 305) and Y-axis (e.g., Y-axis 310) that respectively represent first and second parameters. The first parameter on the X-axis represents time (e.g., a predetermined period of time) that can be divided into different periods of time. The second parameter on the Y-axis represents a ratio of posts (e.g., a proportion of sharing activity to one or more audience types) for a given user. Thus, for a given user, each of the graphs illustrates a “life cycle” of sharing activity that shows when the user shared content and the ratio of sharing activity among one or more audience types over a predetermined period of time. In the examples shown in FIG. 3, the audience types can include public, individuals, custom social circles, predefined social circles and shared audience types. Other audience types can be provided and still be within the scope of the subject technology.

For a first user, the graph 320 shows a graphical element 322 that indicates an instance in which the first user shared content to one or more audience types. Each of the graphs shown in FIG. 3 can include similar graphical elements to the graphical element 322 in order to indicate an instance of sharing activity (e.g., a post) by a user. Thus, it should be understood that a corresponding user is not actively sharing content on each possible time shown in each of the graphs 320, 330 and 340. In the example shown in the graph 320, a line 324 represents that the first user shared 50% of their content or posts to one audience type (e.g., a public audience type indicated as a dashed line) and the other 50% of their content to a second audience type (e.g., a predefined social circle indicated as a dotted line).

The graph 330 shows sharing activity for a more active second user than the graph 320 for the first user. The lines 332 and 334 respectively indicate that the second user symmetrically (e.g., 50% to one audience type and 50% to another audience type) shared content at a first time to a first audience type (e.g., a public audience type as indicated by the dashed line in the line 332) and a second audience type (e.g., a shared group audience type as indicated by the dotted line in the line 334). As the time continues (e.g., going left to right on the X-axis) in the graph 320, the lines 332 and 334 indicate that the second user's ratio of sharing content to the first and second audience types increased at a second time for the first audience type and decreased for the second audience type at the second time. At a third time, the lines 336 and 338 respectively indicate the second user shared content to the first audience type (e.g., the public audience type as indicated by the dashed line in the line 336) and to a third audience type (e.g., an individual audience type as indicated by the multi-dashed line in the line 338). At a fourth time, the lines 336 and 338 indicate that the second user's ratio of sharing content to the first audience type decreased from the second time and increased for the third audience type from the third time.

For a third user, the graph 340 shows a line 342 that indicates an instance of sharing activity to a first audience type (e.g., a predefined social circles audience type as indicated by the dashed line in the line 342) at a first time. As a second time, the line 342 indicates that the ratio of sharing activity has increased to an instance where 100% of the third user's posts are to the first audience type. A line 344 indicates that 100% of the third user's posts are directed to a second audience type (e.g., a custom circles audience type as indicated by the dashed line in the line 344) at a third time and at a fourth time.

Although FIG. 3 illustrates examples for three different users, the subject technology can provide different graphs for any number of users. Additionally, although each of the graphs in FIG. 3 include exemplary graphical representations for different lines and for indicating instances of sharing or posting activity, other types of graphical representations could be utilized and still be within the scope of the subject technology.

FIG. 4 conceptually illustrates an example visualization 400 for a distribution of audience diversity value using a Gini coefficient. In one example, the visualization 400 can be provided for displayed in conjunction with the operations performs in the processes 100 and 200 respectively in FIGS. 1 and 2.

As illustrated, the visualization 400 can be a graph with an X-axis 405 and Y-axis 410 respectively representing first and second parameters. More specifically, the visualization 400 can be a histogram showing a graphical representation of a distribution of data. The first parameter on the X-axis represents a Gini coefficient value that indicates a value for audience diversity based on a proportion of all instances of information sharing during a predetermined period of time over all audience types. The second parameter on the Y-axis represents a frequency of one or more Gini coefficient values for a sample of one or more users. The frequency can represent a number of instances (or cases) for a corresponding Gini coefficient value.

In one example, a low Gini coefficient represents high audience diversity (e.g., sharing to many different audience types). The Gini coefficient values that are higher (e.g, >0.7) and approaching 1.0 represent instances where one or more users are only sharing to a few audience types (e.g., one or two audience types). As shown, the visualization 400 includes a line 420 that indicates that there are over 50 instances corresponding to a Gini coefficient value over 0.7. The line 420 therefore indicates that a large amount of users (when compared to the remaining distribution of Gini coefficient values) shared content to a limit set of audience types. In comparison, the Gini coefficient values approaching zero (e.g., <0.3) are highly diverse. In the example visualization shown in FIG. 4, it can be discerned that the frequency of highly diverse information sharing (e.g., to many audience types) is lower than the frequency of less diverse information sharing (e.g., to fewer audience types). As further shown in FIG. 4, a line 415 represents a mean score (e.g., average) of Gini coefficient values determined for a sample of one or more users.

The type of visualization shown in FIG. 4 can determine how users are interacting with a given social networking service in one example. For instance, the visualization of the frequency of Gini coefficient values can determine, for a given time period (e.g., a day, week, etc.), how users are sharing content to other users in the system. In one example, the visualization in FIG. 4 can indicate that users for a given time period are sharing content that mostly fall within a few audience types (e.g., public group, etc.). A system administrator can then adjust the system in order to attempt to increase the audience diversity in sharing content. For example, user interface changes can be made to the system in order to promote more diverse sharing activity to more audience types in one example.

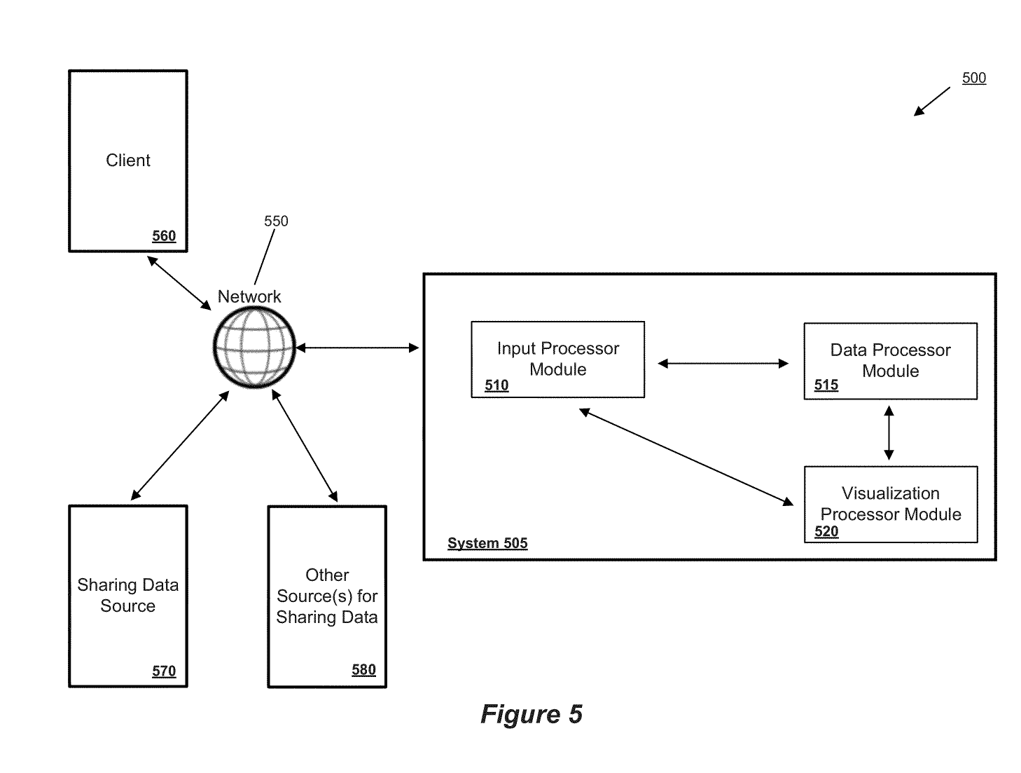

FIG. 5 conceptually illustrates an example computing environment including a system for measuring sharing behavior and audience coverage for one or more users. In particular, FIG. 5 shows a system 505 for implementing the above described processes FIGS. 1 and 2 and the example visualizations shown in FIGS. 3 and 4. In some configurations, the system 505 is part of an implementation running a particular machine.

The system 505 can include memory, one or more processors and one or more modules stored in memory and configured for execution by the one or more processors. As shown in FIG. 5, the system 505 includes several modules for providing different functionality. The system 505 is configured to include an input processor module 510, a data processor module 515 and a visualization processor module 520. The input processor module 510 is configured to extract sharing data from one or more sources of sharing data and generate time-ordered sharing data based on the extracted sharing data. In one example, the sharing data includes one or more user logs. The one or more user logs includes data comprising instances of information sharing, target users, and date and time information, etc. In another example, the sharing data can be raw data (e.g., unformatted sharing data that the input processor module 510 can process).

The data processor module 515 is configured to process the time-ordered sharing data from the input processor and perform one or more statistical evaluations to classify audience coverage and sharing behavior based on the time-ordered data. The data processor module 515 is further configured to determine a proportion of information sharing to one or more audience types for one or more users over a predetermined period of time. The determined proportion of information sharing to the one or more audience types helps define, in part, a pattern of audience diversity for information sharing over time in one example. The data processor module 515 is further configured to determine a proportion of all instances of information sharing during a predetermined period of time over all audience types.

The visualization processor module 520 is configured to provide for display one or more graphical representations of the one or more statistical evaluations from the data processor module. The visualization processor module 520 is further configured generate a first graphical representation based on the proportion of information sharing to each of the one or more audience types for the one or more users over the predetermined period of time (e.g., similar to FIG. 3). The visualization processor module 520 is further configured to generate a second graphical representation based on the proportion of all of the instances of information sharing during the predetermined period of time over all of the audience types (e.g., similar to FIG. 4).

As further shown in FIG. 5, each of the aforementioned modules can be configured to communicate between each other. For instance, different data, messages, API calls and returns can be passed between the different modules in the system 505.

The system 505 can be configured to communicate with sharing data source 570 and other source(s) for sharing data over a network 550. The system 505 can also process sharing data from local storage. A client 560 can be configured to communicate over the network 550 to interact with the system 505. In one example, the client 560 can request and receive the aforementioned graphical representations for display provided by the visualization processor module 520 in the system 505.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

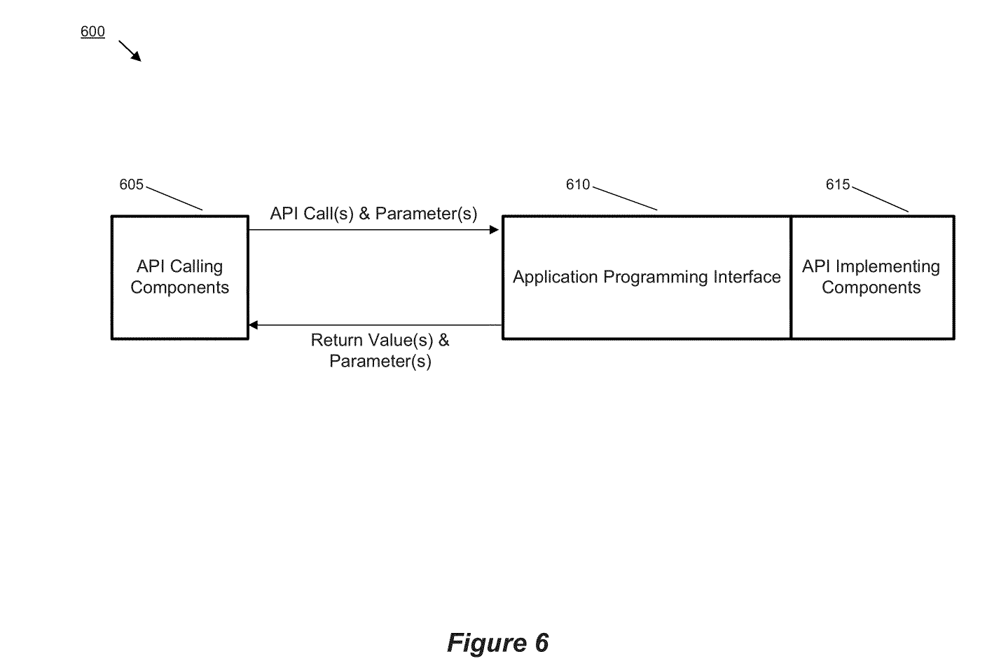

FIG. 6 is a block diagram illustrating an example API architecture, which can be used in some configurations of the subject technology. As shown in FIG. 6, the API architecture 600 includes the API implementing component 615 (e.g., an operating system, a library, a device driver, an API, an application program, software or other module) that implements the API 610. The API 610 specifies one or more functions, methods, classes, objects, protocols, data structures, formats and/or other features of the API-implementing component that can be used by the API-calling component 605. The API 610 can specify at least one calling convention that specifies how a function in the API implementing component receives parameters from the API calling component and how the function returns a result to the API calling component. The API calling component 605 (e.g., an operating system, a library, a device driver, an API, an application program, software or other module), makes API calls through the API 610 to access and use the features of the API implementing component 615 that are specified by the API 610. The API implementing component 615 can return a value through the API 610 to the API calling component 605 in response to an API call.

It will be appreciated that the API implementing component 615 can include additional functions, methods, classes, data structures, and/or other features that are not specified through the API 610 and are not available to the API calling component 605. It should be understood that the API calling component 605 can be on the same system as the API implementing component 615 or can be located remotely and accesses the API implementing component 615 using the API 610 over a network. While FIG. 6 illustrates a single API calling component 605 interacting with the API 610, it should be understood that other API calling components, which can be written in different languages (or the same language) than the API calling component 605, can use the API 610.

The API implementing component 615, the API 610, and the API calling component 605 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

The following description describes an example system in which aspects of the subject technology can be implemented.

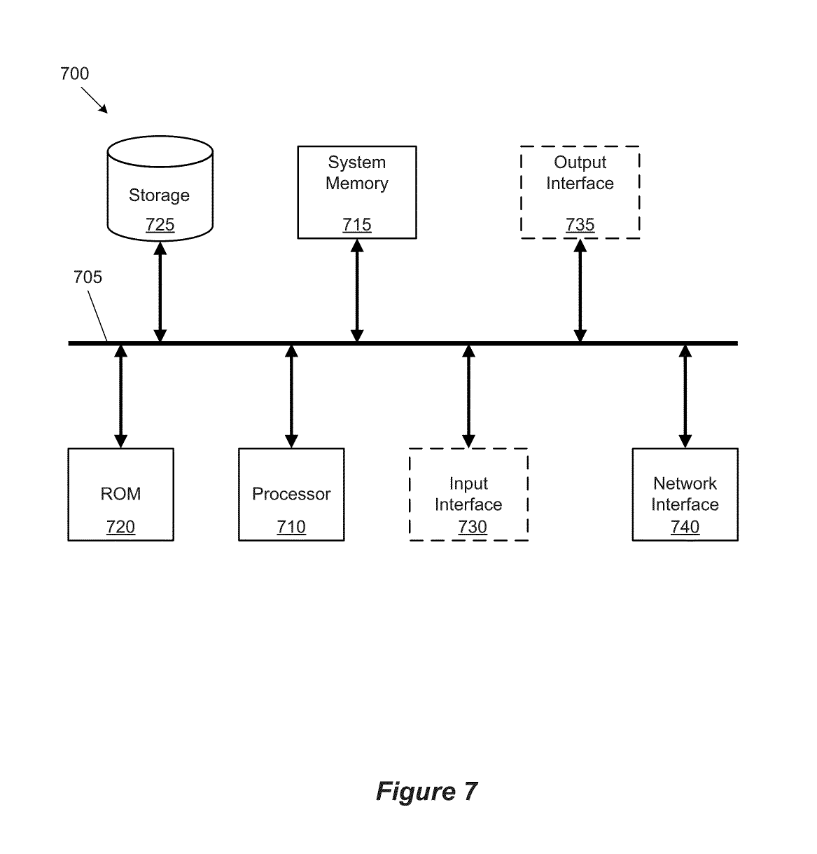

FIG. 7 conceptually illustrates a system 700 with which some implementations of the subject technology can be implemented. The system 700 can be a computer, phone, PDA, or any other sort of electronic device. In some configurations, the system 700 can include a television with one or more processors embedded therein. Such a system includes various types of computer readable media and interfaces for various other types of computer readable media. The system 700 includes a bus 705, processing unit(s) 710, a system memory 715, a read-only memory 720, a storage device 725, an optional input interface 730, an optional output interface 735, and a network interface 740.

The bus 705 collectively represents all system, peripheral, and chipset buses that communicatively connect the numerous internal devices of the system 700. For instance, the bus 705 communicatively connects the processing unit(s) 710 with the read-only memory 720, the system memory 715, and the storage device 725.

From these various memory units, the processing unit(s) 710 retrieves instructions to execute and data to process in order to execute the processes of the subject technology. The processing unit(s) can be a single processor or a multi-core processor in different implementations.

The read-only-memory (ROM) 720 stores static data and instructions that are needed by the processing unit(s) 710 and other modules of the system 700. The storage device 725, on the other hand, is a read-and-write memory device. This device is a non-volatile memory unit that stores instructions and data even when the system 700 is off. Some implementations of the subject technology use a mass-storage device (such as a magnetic or optical disk and its corresponding disk drive) as the storage device 725.

Other implementations use a removable storage device (such as a flash drive, a floppy disk, and its corresponding disk drive) as the storage device 725. Like the storage device 725, the system memory 715 is a read-and-write memory device. However, unlike storage device 725, the system memory 715 is a volatile read-and-write memory, such a random access memory. The system memory 715 stores some of the instructions and data that the processor needs at runtime. In some implementations, the subject technology's processes are stored in the system memory 715, the storage device 725, and/or the read-only memory 720. For example, the various memory units include instructions for processing multimedia items in accordance with some implementations. From these various memory units, the processing unit(s) 710 retrieves instructions to execute and data to process in order to execute the processes of some implementations.

The bus 705 also connects to the optional input and output interfaces 730 and 735. The optional input interface 730 enables the user to communicate information and select commands to the system. The optional input interface 730 can interface with alphanumeric keyboards and pointing devices (also called “cursor control devices”). The optional output interface 735 can provide display images generated by the system 700. The optional output interface 735 can interface with printers and display devices, such as cathode ray tubes (CRT) or liquid crystal displays (LCD). Some implementations can interface with devices such as a touchscreen that functions as both input and output devices.

Finally, as shown in FIG. 7, bus 705 also couples system 700 to a network interface 740 through a network adapter (not shown). In this manner, the computer can be a part of a network of computers (such as a local area network (“LAN”), a wide area network (“WAN”), or an Intranet, or an interconnected network of networks, such as the Internet. Any or all components of system 700 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A machine-implemented method performed on one or more computing devices for measuring sharing behavior and audience coverage for one or more users, the method comprising:
receiving, for each user of the one or more users, data aggregating one or more instances of information sharing by the user over a predetermined period of time, wherein each instance of information sharing includes shared content from the user to a respective one or more recipients of the shared content;
identifying, for each user of the one or more users, a respective one or more audience types corresponding to the respective one or more recipients of the shared content for each of the one or more instances;
determining, for each user of the one or more users, a proportion of information sharing by the user to each of the respective one or more audience types over the predetermined period of time, wherein the determined proportion of information sharing to each of the respective one or more audience types helps define, in part, a pattern of audience diversity for information sharing over time for the user; and
generating, for each user of the one or more users, a respective first graphical representation based on the proportion of information sharing by the user to each of the respective one or more audience types.

2. The method of claim 1, further comprising:
determining a proportion of all of the instances of information sharing during the predetermined period of time over all of the audience types.

3. The method of claim 2, further comprising:
providing for display respective visualizations of the determined proportion of information sharing to each of the one or more audience types and the determined proportion of all of the instances of information sharing.

4. The method of claim 1, wherein the shared content from the user includes at least one of text, picture, video, audio, link, and location data.

5. The method of claim 1, wherein the one or more audience types comprises a set of recipients including a predetermined group of recipients, a user-defined group of recipients, or an individual recipient.

6. The method of claim 5, wherein the one or more audience types further comprises different levels of access for the shared contents including public access or limited access.

7. The method of claim 1, wherein the predetermined period of time comprises one of a day, a week, several weeks, a month, several months, a year, and several years.

8. The method of claim 2, wherein the proportion of all of the instances of information sharing during the predetermined period of time over all of the audience types comprises a Gini coefficient.

9. The method of claim 1, wherein the proportion of all of the instances of information sharing during the predetermined period of time over all of the audience types varies based on a number of audience types.

10. (canceled)

11. The method of claim 1, further comprising:
generating a second graphical representation based on the proportion of all of the instances of information sharing during the predetermined period of time over all of the audience types.

12. The method of claim 1, wherein the first graphical representation indicates a pattern of audience diversity over the predetermined period of time.

13. The method of claim 1, wherein the first graphical representation comprises a graph with an X-axis representing a first parameter and a Y-axis representing a second parameter.

14. The method of claim 13, wherein the first parameter comprises time.

15. The method of claim 13, wherein the second parameter comprises a proportion of audience coverage to one or more different audience types.

16. The method of claim 11, wherein the second representation comprises a graph with an X-axis representing a first parameter and a Y-axis representing a second parameter.

17. The method of claim 16, wherein the first parameter comprises a Gini coefficient value.

18. The method of claim 16, wherein the second parameter comprises a frequency value.

19. A system for measuring sharing behavior and audience coverage for one or more users, the system comprising:
memory;
one or more processors;
one or more modules stored in memory and configured for execution by the one or more processors, the modules comprising:
an input processor module configured to extract sharing data from one or more sources of sharing data and generate, for each user of the one or more user, time-ordered sharing data based on the extracted sharing data, wherein the sharing data comprises one or more user logs, wherein the one or more user logs include one or more instances of information sharing by the user, and wherein each instance of information sharing includes shared content from the user to a respective one or more recipients of the shared content;
a data processor module configured to process the time-ordered sharing data from the input processor and perform, for each user of the one or more users, one or more statistical evaluations to identify a respective one or more audience types corresponding to the respective one or more recipients of the shared contents for each of the one or more instances, and further configured to determine, for each user of the one or more users, a proportion of information sharing by the user to each of the respective one or more audience types over a predetermined period of time, wherein the determined proportion of information sharing to each of the respective one or more audience types helps define, in part, a pattern of audience diversity for information sharing over time for the user; and
a visualization processor module configured to provide for display one or more graphical representations of the one or more statistical evaluations from the data processor module, and further configured to generate a first graphical representation based on the proportion of information sharing to each of the one or more audience types.

20-21. (canceled)

22. The system of claim 19, wherein the data processor module is further configured to determine a proportion of all instances of information sharing during a predetermined period of time over all audience types.

23. (canceled)

24. The system of claim 19, wherein the visualization processor module is further configured to generate a second graphical representation based on the proportion of all of the instances of information sharing during the predetermined period of time over all of the audience types.

25. A non-transitory machine-readable medium comprising instructions stored therein, which when executed by a machine, cause the machine to perform operations comprising:
receiving, for each user of the one or more users, data aggregating one or more instances of information sharing by the user over a predetermined period of time, wherein each instance of information sharing includes shared content from the user to a respective one or more recipients of the shared content;
identifying, for each user of the one or more users, a respective one or more audience types corresponding to the respective one or more recipients of the shared content for each of the one or more instances;
determining for each user of the one or more users, a proportion of information sharing by the user to each of the respective one or more audience types over the predetermined period of time, wherein the determined proportion of information sharing to each of the respective one or more audience types helps define, in part, a pattern of audience diversity for information sharing over time;
determining a proportion of all of the instances of information sharing during the predetermined period of time over all of the audience types; and
generating, for each user of the one or more users, a respective first graphical representation based on the proportion of information sharing by the respective user to each of the one or more audience types.
